(19) United States
(12) Patent Application Publication
(10) Pub. No.: US 2021/0150539 A1
(43) Pub. Date: May 20, 2021

(54) SYSTEMS AND METHODS FOR EXCHANGING ITEMS AND VERIFYING OWNERSHIP

(71) Applicant: Tricopian, LLC, Del Mar, CA (US)

(72) Inventor: Chi W. Yau, Escondido, CA (US)

(21) Appl. No.: 17/096,864

(22) Filed: Nov. 12, 2020

Related U.S. Application Data
(60) Provisional application No. 62/935,570, filed on Nov. 14, 2019.

(51) Int. Cl. G06Q 30/00; G07C 9/37; G06K 7/10; G06Q 30/02; G06F 16/901

(52) U.S. Cl. CPC G06Q 30/018; G07C 9/37; G06K 7/10297; H04W 4/35; G06Q 30/0215; G06F 16/9017; G06K 2007/10504; G06Q 30/0208

(57) ABSTRACT

In some aspects, a method of associating an item with a user profile is disclosed. The method comprises receiving an input indicating that the item will be deposited, receiving the item, determining whether an identifier of the user profile is not received relative to receipt of the item, concurrent with receiving the item, monitoring a vicinity of the receiving receptacle, generating identifying information for a user that deposits the item, identifying a source from which to request user identity information, contacting the identified source, receiving the user identity information for each individual in the vicinity of the receiving receptacle when the item is received, identifying the user that deposits the item into the receiving receptacle, identifying the user profile associated with the identified user, and associating the item received with the identified user profile.

### CROSS-REFERENCE TO RELATED APPLICATIONS

This application claims priority to U.S. provisional Application No. 62/935,570 filed Nov. 14, 2019 and titled “SYSTEMS AND METHODS FOR EXCHANGING ITEMS AND VERIFYING OWNERSHIP”, which is incorporated by reference herein in its entirety. Any and all applications for which a foreign or domestic priority claim is identified in the Application Data Sheet as filed with the present application are hereby incorporated by reference under 37 CFR 1.57.

### BACKGROUND

### Field

This innovation relates to exchanging and/or depositing products, and particularly to the field of exchanging or depositing products in return for goods, services, and/or other compensation, for example reusable and/or recyclable products such as rechargeable batteries, cellular phones, electronics products, products containing rechargeable batteries, or other items that may have some value, intrinsic or extrinsic in being re-used, recycled, exchanged, etc.

### Description of the Related Technology

Countless products are exchanged each day. Many of these products have intrinsic or extrinsic value, and the owner and/or recipient of the products may desire to ensure that the product is associated with the owner in a verifiable and trackable way. In some embodiments, the products are electronic products and/or receive power from batteries or similar energy storage components. For example, the batteries may degrade over time and with use or components in the devices may be replaced with newer technology making products obsolete. As such, the products may be exchanged for replacement products having new or refurbished batteries as a way to extend the lives of the batteries or exchanged for credit or similar monetary value for later use. As more products become replaceable, short-lived, and/or temporary, consumer demand for such exchanges of products is expected to increase.

### SUMMARY

In some aspects, a method of associating an item with a user profile is disclosed. The method comprises receiving an input indicating that the item will be deposited into a receiving receptacle. The method further comprises receiving the item in the receiving receptacle, determining whether an identifier of the user profile is not received relative to receipt of the item in the receiving receptacle, concurrent with receiving the item in the receiving receptacle, monitoring a vicinity of the receiving receptacle for vicinity information, and generating identifying information for a user that deposits the item into the receiving receptacle based at least in part on the vicinity information. The method also comprises identifying a source from which to request user identity information based on the generated identifying information, contacting the identified source with the generated identifying information to request the user identity information for each individual in the vicinity of the receiving receptacle when the item is received in the receiving receptacle, receiving the user identity information for each individual in the vicinity of the receiving receptacle when the item is received in the receiving receptacle, and identifying the user that deposits the item into the receiving receptacle based at least on an analysis of the received user identity information for each individual in the vicinity of the receiving receptacle when the item is received in the receiving receptacle and generated identifying information. The method additionally comprises identifying the user profile associated with the identified user and associating the item received in the receiving receptacle with the identified user profile.

In some embodiments, the identifier of the user profile is not received relative to receipt of the item in the receiving receptacle when the identifier of the user profile is not received within a threshold period of time of the receipt of the item in the receiving receptacle. In some embodiments, the vicinity information comprises one or more of wireless communication information, captured images of the vicinity, biometrics information, time information, environmental information, or identifier information. In some embodiments, the wireless communication information comprises a cellular communication module identifier, a Bluetooth communication module identifier, a Wi-Fi communication module identifier, or a near-field communication module identifier. In some embodiments, the captured images comprise images of faces or other identifying features of individuals that interact with the receiving receptacle or enter into a threshold area around the receiving receptacle. In some embodiments, identifying a source from which to request user identity information based on the generated identifying information comprises determining a type of identifying information generated based at least in part on the vicinity information. In some embodiments, the user identity information comprises one or more of a user name, a user address, a user e-mail address, a user phone number, or a user profile identifier.

In some aspects, a system for associating an item with a user profile is disclosed. The system comprises a receiving receptacle configured to receive the item deposited by a user, an input circuit configured to receive an input indicating that the item will be deposited into the receiving receptacle, a memory circuit configured to store instructions, and a hardware processor configured to, in response to the instructions, identify an identifier of the user that deposited the item into the receiving receptacle, determine, based on a lookup table stored in a data store, a user profile identifier that corresponds to the identifier of the user, and associate a tag identifier with the user profile identity. The tag identifier is uniquely associated with the item deposited by the user in the receiving receptacle.

In some embodiments, the system further comprises a tag scanner configured to scan a tag associated with the item deposited into the receiving receptacle and identify the tag identifier for the tag associated with the item deposited into the receiving receptacle. In some embodiments, the hardware processor is further configured to generate an update to a user profile of the user to indicate that the user deposited the item into the receiving receptacle. In some embodiments, the system further comprises a detection circuit configured to detect when the item is deposited in the receiving receptacle and identify one or more parameters of the item deposited into the receiving receptacle and a plurality of environmental sensors configured to monitor aspects of an environment of the receiving receptacle and capture information of potential users in the environment when the detection circuit detects that the item is deposited into the receiving receptacle. In some embodiments, the system further comprises a communication circuit configured to communicate with a central server and one or more external data sources, wherein the hardware processor is further configured to communicate with the one or more external data sources to confirm an identity of the user that deposited the item into the receiving receptacle based on the captured information of the potential users in the environment when the item was deposited into the receiving receptacle.

In another aspect, a method of depositing an item in a receiving receptacle is disclosed. The method comprises providing a unique tag for scanning by a user using a user device, the unique tag associated with the item being deposited into the receiving receptacle, providing the receiving receptacle for access by the user depositing the item, receiving the item in the receiving receptacle, and receiving a user identifier for the user via an interface, the user identifier associated with the unique tag by the user device. The method also comprises scanning the unique tag for the item deposited into the receiving receptacle and updating a user profile having the user identifier for the user to indicate that the item associated with the unique tag was deposited into the receiving receptacle.

In some embodiments, the unique tag associated with the item comprises a removable tag physically coupled to the item being deposited into the receiving receptacle, an identifier for an envelope or container into which the item is placed for depositing into the receiving receptacle, a displayed tag identifying the receiving receptacle into which the item is deposited, or an electronic identifier for the item being deposited into the receiving receptacle. In some embodiments, the interface comprises a physical interface at the receiving receptacle, a graphical user interface at the receiving receptacle, or a communication interface between the user device and the receiving receptacle. In some embodiments, the received identifier comprises an identifier for the user profile. In some embodiments, the method further comprises identifying an offer for which the user has registered or is eligible, determining whether the deposited item in the receiving receptacle qualifies for the offer, and updating the user profile based on the determination whether the deposited item in the receiving receptacle qualifies for the offer. In some embodiments, determining whether the deposited item in the receiving receptacle qualifies for the offer comprises identifying the item deposited in the receiving receptacle, determining, based on the identified offer, a list of qualifying items eligible for the offer and a benefit of the offer, determining that the item deposited in the receiving receptacle matches one of the qualifying items, and update the user profile to include the benefit of the offer based on the determination that the item deposited in the receiving receptacle matches one of the qualifying items. In some embodiments, the method further comprises scanning the item deposited in the receiving receptacle to capture one or more features of the deposited item. In some embodiments, scanning the deposited item comprises one or more of capturing an image of the deposited item, weighing the deposited item, or scanning the deposited item for or with radio waves or signals.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 depicts a front view of one embodiment of an exchange machine.

FIG. 2 is a schematic illustration of one embodiment of the functional blocks of the exchange machine of FIG. 1.

FIG. 3 depicts a “headless” exchange machine.

FIG. 4A depicts a first example of an identifiable feature of a product accepted by the exchange based machine of FIG. 1, for example an end view of an embodiment of a product having visually identifiable concentric rings and/or identifying codes.

FIG. 4B depicts a second example of an identifiable feature of the product, for example an end view of an embodiment of the product having a radial barcode.

FIG. 4C depicts a third example of an identifiable feature of the product, for example an end view of an embodiment of the product having a quick-recognition code and a high capacity color code.

FIG. 4D depicts a fourth example of an identifiable feature of the product, an end view of an embodiment of the battery having a radial QR-type code.

FIG. 5 depicts an example method of identifying a user that deposited an item into the exchange machine of FIG. 1 without the user providing corresponding user information.

FIG. 6 is one embodiment of a communication flow diagram 600 depicting communications exchanged between, for example, the exchange machine of FIG. 1, a user device, and a central processor or storage.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some embodiments disclosed herein relate to devices configured to enable tracking of ownership of an exchanged product. The product may comprise a consumable product, an item being transported, an electronic device, a collectible product, a vehicle, clothing, luggage, a pet, and any item of intrinsic or extrinsic value. In essence, the product may be any physical object that can be exchanged and/or conveyed from one person or entity to another person or entity. In some embodiments, the tracking of ownership comprises placing a physical tag on or associated with the product, and/or using an identifier, such as a serial number or other code or unique identifier that is on a product or item. The tag may comprise any one of a printed barcode, including, a linear barcode, a 2-D barcode, a QR code, or any other type of barcode printed, a printed alphanumeric, text, or graphical code, a radio frequency identifier (RFID) tag, a Bluetooth tag, or other similar unique identifier. In some embodiments, the physical tag may be associated with a bag, container, or similar housing or enclosure into which one or more products can be inserted. In some embodiments, the tag may be a broadcast, wireless, or electronic tag.

In some embodiments, the physical or electronic tag is associated with an electronic or profile identifier. For example, the tag identifier, which may have a name, number, or the like, can be associated with a profile for the person who deposited the product into a deposit bin or receptacle. The profile for the person may associate the person's name with various identifying information, for example an account number, the printed barcode, and so forth. The identifier may be stored in a database and associated with the product (for example, a serial number of the product, name of the product, and so forth) and an identifier for the owner of the product (for example, an account number of the owner, a name of the owner, and so forth). The database may be one of any formats of databases, including a distributed ledger (for example, using a “blockchain”), an Excel spreadsheet, or any other database structure.

Once the tag is applied to the product, the devices (for example, such as a mobile phone, tablet, laptop, or similar mobile computing device) may be used to scan the tag and associate the tag with the user of the device. In some embodiments, an item can be associated with an owner by scanning a tag. A scanning device, such as a smartphone or tablet computer, can store information identifying a user. When a tag is scanned to establish ownership, the user identifying information can be passed from the smartphone or tablet computer to a server or database and be associated with the tag or the identifier in the tag. For example, if a first entity is conveying the product to a second entity, then the first entity may scan the tag (for example, with a barcode scanner or similar scanning device for the particular tag on the product) that was previously applied to the product and then initiate a transfer of the ownership, stewardship, or custodianship of the product to the second entity. The transfer of ownership may involve updating the database that associates the tag identifier with the owner identifier. As such, when transferring ownership of the product, the first entity may scan the tag on the product with its device and initiate the transfer, which may include removing the first entity's identifier from the association with the tag identifier and adding the second entity's identifier to the association with the tag identifier. In some embodiments, the database may store and/or track a chain of prior owners of the product and/or what the product was exchanged for, if anything.

For example, a person may switch from a first phone company to a second phone company and have a phone or other equipment from the first phone company to trade in to the second phone company. In exchange for trading in the phone equipment, the second phone company may offer a monetary credit or equipment. Thus, the person may wish to trade in the equipment from the first phone company.

To facilitate the exchange (i.e., the deposit of the equipment from the first phone company by the person), the second phone company may utilize drop off receptacles, for example, such as the vending machines described herein, but may be another type of receptacle that is designated to accept such deposits. In some embodiments, the second phone company can contract with a provider of the receptacle for services related to the exchange. The drop off receptacles may enable the second phone company to offer drop off locations for the products in multiple locations even if the second phone company does not have store at those locations. Thus, the drop off receptacles may enable the person to provide the equipment being exchanged or turned in to the second phone company without necessarily visiting a store of the second phone company. The drop off receptacles may have codes thereon which can be scanned via mobile computing devices to transact a deposit or drop-off via a mobile application.

As part of the exchange process, the drop off location may associate the equipment dropped off by the person that is from the first phone company with a user profile or other account information for the person. For example, deposit of the equipment from the first phone company may involve the person obtaining, from the drop off receptacles, a tag for the equipment. The tag can be printed on, for example, a deposit bag, an envelope, a container, and the like. In some embodiments, the receptacle can provide tags, such as printable QR codes, stickers, etc., that can be generated at the receptacle in response to a user request, and which can be attached or affixed to the item by the user prior to deposit in the receptacle. The person may utilize an application or similar software on a mobile device or an interface of or associated with the drop off receptacles to associate the obtained tag with the person's account. For example, a user may login to his/her/their profile or account (via the mobile device application or receptacle interface) before or while scanning the tag. Once the tag is scanned, the application or software or interface may automatically associate the scanned tag with the person's profile from the mobile application or stored in servers in communication with the receptacle interface, and also convey the person's profile information to a control system associated with the drop-off receptacle and corresponding interface. In some instances, the drop-off receptacle may include a receptacle for placement of the tagged product or a receptacle that is associated with the specific tag and a sensor that detects placement of the tagged product into the receptacle.

Thus, the drop off receptacle may enable the person to associate their user profile with the product being deposited, deposit the product, and have corresponding information conveyed to the second phone company without actually interacting with anyone or traveling to the second phone company. This may simplify the drop off process for the person. Furthermore, the automated drop off receptacle may enable the second phone company to offer exchange or similar promotions without having to dedicate staff and/or store locations to manage such exchanges of equipment at all hours.

Thus, the drop-off receptacles and the second phone company may work together to track deposit of the product into the drop-off receptacle and corresponding person's profile information. The second phone company may use the information to track the deposited equipment and provide the person with the appropriate exchange value or equipment based on the actual equipment deposited by the person into the drop-off receptacle, for example updating the person's profile based on the offer by the second phone company. Thus, when the person deposits the equipment into the receptacle, the second phone company automatically receives information regarding the deposit and applies the appropriate credit or exchange to the person's account or profile. In some embodiments of the example, the first and second phone companies need not be separate entities. That is, the exchange process for a product may be with a single entity which issued or provided the deposited item, and which will receive the deposited item.

In some instances, one or more of the control system of the drop off receptacle, the person's profile, or the exchange of information between the control system and the second phone company utilize a blockchain for storage and association of information. A “blockchain” is a list or chain of records, for example, stored as blocks, which are linked and secured using cryptography and which may grow as additional records are added to the chain. The blocks may include information of previous blocks, time information, and transaction information or data, and the like. Each blockchain may be distributed between various users or systems and generally provide unilateral resistance to modification or corruption of data contained in the blockchain or any blocks therein by any individual entity. The blockchain may generally provide a distributed ledger that can be used to permanently record information of transactions such that they are easily and publicly verifiable. When used in conjunction with the distributed ledger, the blockchain may be managed by a peer-to-peer (P2P) network that utilizes a specific protocol or protocols for validating new blocks and providing consensus to the information in the blockchain. Generally, data stored in the blocks of the blockchain cannot be altered retroactively without the alteration of all corresponding distributed blocks. In some embodiments, the blockchain may be used in conjunction with the exchange or products between entities described herein. For example, each tag may be associated with a unique block chain such that each time the tag is used with a new product, the tag's blockchain is updated with profile information for the person that deposited the product, the offer associated with the product deposit, time and date information for the deposit, location information for the deposit, and the like. A subsequent scan of the tag after an ownership association has been made or upon a transfer of ownership will identify the user established when the tag was first scanned. In this way transactions can be performed without the need for a user to input a lot of information, or without inputting any information, and simply providing the item with the tag thereon. A scan of the tag will identify the user or owner, and can be used to send a replacement item, repaired item, new item, to credit an account, and the like. Similarly, each drop off location may have its own blockchain that is updated with details of each product deposit, or each person profile has its own blockchain that includes information for all deposits, offers, and the like.

Some embodiments disclosed herein relate to machines (i.e., the drop off receptacles) configured to enable the drop off and/or exchange of products. For example, the drop off machine may comprise one or more receptacles, a user interface, one or more physical tags, wireless communication capabilities and components, proximity detection sensors, cameras and/or monitoring equipment, and the like. In some instances, the drop off receptacles may be used for two-way exchange-based vending. In some embodiments, the two-way exchange-based vending can be subscription based, rental based, membership based (e.g. club membership), or based on any other system for tracking and/or regulating the exchange of a returned item for a new item, where the returned item and the new item includes the tag described herein. In some embodiments, the exchanged item can be any desired item, and can, in some embodiments, be a reusable item, such as, for example, a printer ink cartridge, a razor blade, a fuel cell such as, a portable fuel cell, a rechargeable battery, or any other item, that has a unique tag disposed thereon or attached thereto. Thus, in some embodiments, the machine can be configured to receive and/or vend a variety of items, including, for example, rechargeable batteries, phones, books, electronics, jewelry, and so forth. In some embodiments, an exchange machine can comprise a variety of features in a variety of combinations. In some embodiments, these features can be configured to perform designated functions. Some embodiments include a vending machine capable of performing more or fewer functions than those described herein. In some embodiments, features of the exchange machine can include, for example, a scanner module, a communications module, a receiving module, a rejection module, a dispensing module, a processor, memory, a network communications module, and/or any other desired features. In some embodiments of the exchange machine, the exchange machine can scan a tag disposed on a product and associate the tag with a user identifier such that the tag (and the product) can be associated with each other. In some embodiments of the exchange machine, the exchange machine can communicate with a central control and monitoring station. In some embodiments of the exchange machine, the exchange machine can communicate with a central control and monitoring station over a network, such as, for example, the internet, a telecommunications network, or any other network. In some embodiments, the exchange machine can communicate information such as, for example, inventory status, functionality status of the exchange machine, service requests, subscription verification requests, and/or any other desired information to the central control and monitoring station.

Some embodiments disclosed herein relate to optional partial exchange of a product. For example, when the product includes a component that degrades or wears over time, the owner of the product may not want to replace the entire product when only the degraded or worn portion is defective. The exchange receptacle or machine described herein may be configured to enable such partial exchange or credit exchange of products. For example, the entity may own a product with a rechargeable battery (for example, a mobile phone, wireless headphones, laptops, and the like) and the rechargeable battery may degrade and not hold a charge. The entity may not wish to purchase a new product because only the battery is bad and may instead wish to pay for only a new battery. The exchange machine may enable such an exchange. The exchange machine may scan a tag on the product being deposited and allow the entity to request to replace the product (or a component thereof) while also indicating which component needs to be replaced. As such, the exchange machine may provide the entity with a credit for the portions of the product that are operational (for example, that do not need to be replaced) and apply that credit against the product that the exchange machine vends to the entity. For example, if the owner needs to exchange a cell phone that is in good condition except for the battery, the exchange machine may enable such an exchange. Where the phone is worth $50 in good condition with all working components, the identification of the battery as needing to be replaced may remove 50% of the value of the phone in good condition. When the owner deposits the phone in good condition but the bad battery into the exchange machine, the machine may credit the owner's account with $25. In some instances, the association of the deposited item and the owner's account may be maintained such that the deposited phone can be evaluated to make sure that the phone was it good condition and/or that the battery is the only item to be updated. Through such an exchange system, a majority of a total cost charged may be associated with the battery, since the entity is effectively buying only a new battery with the rest of the deposited product being substantially similar to the vended product.

The exchange machine (and/or the entity's mobile device) may update the tags associated with the deposited and vended products. When the exchange machine scans the tag of the product being deposited, the exchange machine may update the database relating to ownership of the product to indicate that the deposited product is now owned by the vending machine and not the entity. When vending the vended product, the exchange machine may scan the tag on the vended product and update the database relating to ownership of the product to indicate that the vended product is now owned by the entity. In some embodiments, the entity's device may perform the updates to the ownership database of the deposited and vended products. Additionally, the exchange machines may use the ownership database to track the credits and/or charges to the entity. For example, when the entity deposits a product having a credit value associated therewith, the exchange machine may update the ownership database to indicate that a particular entity identifier has a credit (or charge) associated therewith. In some embodiments, if the entity deposits a product and erroneously indicates that a portion of the product is still working, then the exchange machine may charge the entity for portions of the product that were replaced in excess of what the entity initially indicated. In some instances, the exchange machines may update ownership records for the user profile when the corresponding user deposits the product in the exchange machines so as to show that “ownership” or “possession” of the product has passed to the exchange machines.

Some embodiments disclosed herein relate to methods of exchange of, for example, electronics and other valuables. Some embodiments can include a variety steps performed in a variety of orders. Some embodiments can include more or fewer steps than those specifically outlined herein. In some embodiments, the steps outlined herein can be supplemented by additional steps. In some embodiments, methods of exchange based vending of, for example, electronics or other items can include, for example, receiving a deposited item, identifying the person that deposited the item, updating records to show changes in ownership and/or possession, and updating records to show qualification of or for benefits of an exchange, including monetary or product based benefits. In some instances, where the exchange involves providing an item with at least one replaced component, the exchange system may further verify value information for the exchanged component, verifying product condition for the deposited product, verifying inventory availability of the needed or desired product, dispensing the desired product, and/or any other desired steps.

Some embodiments disclosed herein relate to methods of exchanging products, for example products including rechargeable batteries, although any other product of value can replace the example of rechargeable batteries. Some embodiments can include using an application (on a mobile device or on a vending machine) to scan a tag on a product. The application automatically identifies or creates an association of the product with an owner. The entity can then do various things with the product that the application then automatically updates in the ownership database. For example, if the entity is depositing the product, then the application updates the ownership database to show the vending/depositing location as the owner. If the entity is transferring ownership to a second entity, then the application may update the ownership database to show the second entity as the owner.

In some embodiments, the entity's mobile device may automatically communicate with the exchange machine so that the entity does not need to manually interact with the exchange machine. For example, the entity's mobile device may communicate wirelessly (for example, via Bluetooth, Wi-Fi, NFC, digital barcode, and so forth) to allow the entity to interact with the exchange machine.

A exchange machine can comprise a variety of shapes, sizes and configurations. In some embodiments, the exchange machine can be sized for floor mounting, for wall mounting, for table/countertop mounting, or for any other desired mounting configuration. In some embodiments, the exchange machine can comprise an integral component of another exchange machine, such as, for example, the battery exchange machine.

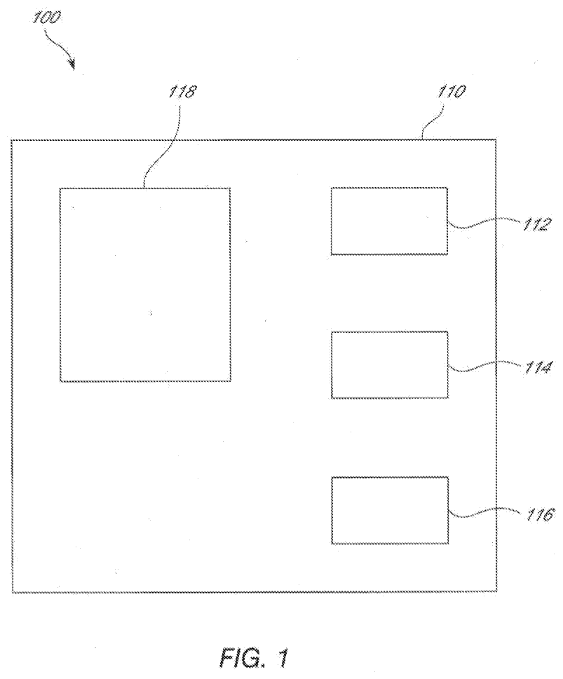

An exchange machine as described herein can comprise a variety of functions to facilitate product exchanges and/or returns. FIG. 1 depicts one embodiment of the exchange machine 100. As depicted in FIG. 1, the exchange machine 100 can comprise a body 110, a receiving module 112, a rejection module 114, a dispensing module 116, and a communications module 118. Though not shown in FIG. 1, the exchange machine 100 may include a scanner module to scan a tag disposed on the product being exchanged (for example, a battery, a cell phone, a laptop, or any other product being exchanged by an entity) and/or scan the entity's mobile device or other otherwise obtain an identifier for the entity. The exchange machine 100 may further comprise a user interface that allows users to interact with the exchange machine 100.

In some embodiments, the body 110 can comprise the exterior of the exchange machine 100. The body 110 can be made of a variety of materials including, for example, natural, manmade, or any other desired materials, or a combination thereof. In some embodiments, for example, the body 110 can comprise one or more of a polymer or a metal. The body 110 can be designed and configured to house and protect the components and the products stored in the exchange machine 100. In some embodiments, the body 110 can include features to facilitate access to the components of the exchange machine 100 and the products deposited and stored in the exchange machine 100 such as, for example, a door, a lock, and/or any other desired features.

The exchange machine 100 can include the receiving module 112. In some embodiments, the receiving module 112 (and the exchange machine 100 as a whole) can be configured to receive one or several products at one time, to identify the one or more received products, to determine the acceptability of the one or more received products, to determine the operability of the one or more received products, to communicate the identification, acceptability, to convey operability information for the one or more received products to a controller, to place the one or more received products in a storage receptacle for received products (for example, according to a corresponding company, client, and so forth), and/or to associate deposited products with a particular user, user profile, or entity).

The receiving module 112 can include a variety of components that provide a variety of features and perform a variety of functions. In some embodiments, for example, the receiving module 112 can comprise a receiving receptacle configured to receive products and a receiving identifier component (for example, a camera or similar sensor configured to identify one or more received products), a storage receptacle for storing received products, and a tag dispenser for dispensing uniquely identified tags, bags, or the like into which the deposited products are placed or with which the products are marked before being placed into the receiving receptacle. In some embodiments, the receiving module 112 may further comprise features configured to transport or move the one or more received products from the receiving receptacle to the storage receptacle. For example, when the receiving module 112 may include sensors or similar components in the receiving receptacle to identify, quantify, or otherwise analyze the received products. Therefore, the receiving module 112 may transfer products from the receiving receptacle to the storage receptacle to make space for additional products to be deposited into the receiving module 112. In some embodiments, the receiving module can include each or some of these features. In some embodiments, the receiving module 112 can include additional features. In some embodiments, one or several of these features can be integrated into a single location.

In some embodiments, the receiving identifier can include features configured to identify the received products, for example by capturing an image of the received products, scanning for physical or electronic identifiers or signals, capturing the weight of the products, and so forth, to perform an identification of the products. This identification can, for example, comprise identification of a type, class, or category, a brand, a size, and other identifying features of each deposited product. In some embodiments, this identification can comprise identification of some parameter associated with the product. Advantageously, identification of the type, class, or category or other identifying features or parameters of each deposited product can be used to identify a corresponding value associated with the deposited item. For example, the receiving module 112 may identify a brand or model of the deposited product based on a captured image, weight, or captured identifier of the deposited product.

In some instances, the identification (for example, the brand, model, serial number, and the like) of the deposited product can be associated with the profile, account, name, etc. of the entity that deposited the product. In some instances, the identification can indicate whether the entity has a valid and/or active user subscription or active exchange request, for example with a vendor that provides the exchange machine 100 or a company or other entity with which the vendor of the exchange machine 100 has an agreement or arrangement to collect products. In some embodiments, for example, a user may wish to return a rented item (for example, book, battery charger, portable battery, headphones, and the like) using one of the exchange machines 100. The exchange machine 100 may accept the deposited product and determine whether the deposited product can be accepted by the exchange machine 100 and associated with the user's account. For example, if the user deposits a rechargeable battery into the exchange machine 100 receiving module 112, the exchange machine 100 may determine that the user can receive one or several batteries in exchange for the deposited rechargeable battery based on the subscription account. Each of the products can include features that identify the product or allow identification of the product and association with the user's account. As a user's possession of subscription products coincides with, in some embodiments, the active status of their subscription, the identification of a product as a subscription product simultaneously identifies a valid and/or active subscription.

In some embodiments, the receiving identifier can use a variety of techniques to determine the acceptability of the received product. In some embodiments, the receiving identifier can include features configured to determine the physical condition of the received product and/or configured to determine the operable condition of the received product. In some embodiments, for example, the receiving identifier can include a scanner, a camera, or any other feature capable of capturing an image of the received product. This image can, in some embodiments, be analyzed with different image analysis techniques to determine the condition of the exterior of the product. In some embodiments, the receiving identifier can obtain information from the user, for example via an interface requesting details of the product being deposited into the exchange machine 100 by the user (for example, via the user's computing device) or from a scan of neighboring user devices when the product is deposited

In some embodiments, the receiving identifier can include features configured to determine the operable condition of the received battery. These features can include, for example, one or more electrodes configured for electrical connection with the received battery. In some embodiments, the electrodes can be connected with features configured to determine the ability of the received battery to be recharged and meet performance requirements.

In some embodiments, the receiving module 112 can access the inventory module and can comprise features configured to transport a received battery to the inventory module. In some instances, the receiving module 112 may comprise a compartment or receptacle configured for placement of the tagged product for processing by the exchange machine 100 after initial processing by the user depositing the product (e.g., scanning of the tag with the user device). In some embodiments, the receiving module 112 may comprise the scanning devices configured to scan the product and identify different parameters, features, and/or aspects of the deposited product.

As mentioned above, the exchange machine 100 can include the rejection module 114. In some embodiments, the rejection module 114 can be configured to return rejected products to the user. In some embodiments of the exchange machine 100, information obtained from the receiving module 112 can be used to determine whether to accept or reject received products. In some embodiments, for example, a received product can be rejected if the physical condition of the received product is inadequate or if a model of the received product is not as implicated and/or expected. In some embodiments, for example, a received product can be rejected if the operable condition of the product is inadequate or if the product is of an unrecognized brand, model, size, etc. In some embodiments, for example, a received product can be rejected if the physical condition and the operable condition of the product are inadequate. In some embodiment, the rejection module 114 can be configured to reject a product, for example, if the product is a non-supported type or brand of product, if the product does not include a proper identification feature or based on any other desired criteria, and so forth. In some instances, the rejection module 114 may reject a rejected product into a particular receptacle for the user to pick up or may otherwise segregate the product in inventory for further evaluation or return to the user.

The rejection module 114 can include a variety of features and components. In some embodiments, the rejection module 114 can include, for example, the rejection receptacle. In some embodiments, the rejection module 114 can include additional features. In some embodiments, one or several of these features can be integrated into a single location. In some embodiments, the rejection module can comprise an integral portion of the receiving module 112 and/or the dispensing module 116.

In some embodiments, the rejection receptacle can be configured to receive rejected products from the receiving module 112 and to present the rejected products to the user. In some embodiments, the rejection receptacle can comprise, for example, a user accessible tray.

The exchange machine 100 can include the dispensing module 116. The dispensing module 116 can be configured to remove one or more products from the inventory module and dispense the one or more products to the user. In some embodiments, the dispensing module 116 can dispense the number of products associated with a transaction, for example when a device having a battery or other replaceable component is deposited to obtain a similar device with the replaced component.

The dispensing module 116 can include a variety of features and functionalities. In some embodiments, the dispensing module 116 can include, for example dispensing features configured to deliver one or more batteries from the inventory module to a user, and any other desired features. The dispensing module 116 can provide the user with a replacement product, for example when the product being deposited has a subset of components to be replaced but value exists for the remaining component(s).

Some embodiments of the exchange machine 100 include the communications module 118. The communications module 118 can be configured to communicate with a user of the exchange machine 100. Specifically, in some embodiments of the exchange machine 100, the communications module 118 can be configured to communicate information to the user and/or to receive inputs from the user. In some instances, the communications module 118 may communicate with other communications modules 118 or a centralized processor or controller. For example, the communications module 118 may communicate the scanned information or communicate use profile and/or tag information with user devices and/or the external data sources.

In some embodiments, the communications module 118 can be static and/or dynamic. Thus, in some embodiments, the communications module 118 can comprise active features capable of providing information in response to an input, and in some embodiments, the communications module 118 may constantly display the same information. Thus, in some embodiments, the communications module 118 can comprise text, images, coding, or other static features located on a portion of the exchange machine 100, and in some embodiments, the communications module 118 can include, for example, a display screen, a speaker, or any other feature or feature combination capable of communicating information to a user of the exchange machine 100. In some embodiments, a communications module 118 can comprise one or several input features such as, for example, a key pad, a touch screen, a track pad, a microphone, voice recognition hardware and software, or any other feature or features capable of receiving a user input.

In some embodiments, the communications module 118 comprises features configured to facilitate online interaction with the exchange machine 100, with other exchange machines 100, with the centralized controller, sources of external data, and the like. Specifically, in some embodiments, the communications module 118 can comprise features to facilitate interaction with a web-site (for example, an interface for the exchange machine) or other reference or information source. In some embodiments, the web-site (or other source) can have a communications link with the exchange machine 100 to transmit information relating to user interaction with the web-site or the user interface to the exchange machine 100. Thus, in some embodiments, information relating to a transaction performed at the exchange machine can be communicated to the exchange machine 100.

In one embodiment of the exchange machine 100, the communications module 118 can comprise the user interface comprising a touch screen configured to communicate information to the exchange machine 100 user and to receive inputs from the user or other external systems, for example the central controller, external sources, and so forth.

In some embodiments, the communications module 118 of the exchange machine 100 can communicate information to a user including, for example, the availability and costs of a new or expanded subscription or exchange program, information relating to a user account and/or user subscription account, or other exchange completed, in process, proposed, and so forth, such as, for example, the status of the users subscription account, status of the current or previous exchange, the acceptability of deposited products, and/or any other desired information, and so forth.

In some embodiments, the communications module 118 transmits information to a user and receives inputs from a user relating to a transaction, for example the deposit of a product. In some embodiments of the exchange machine 100, the communications module 118 can prompt a user for an input identifying the user account and/or user subscription account, for example when the user scans the tag on or of the product being deposited. In some embodiments, the communications module 118 can be further configured to receive user inputs identifying the user account and/or the user subscription account. These inputs can include, for example, a username and password, a unique user identification number (for example, of the tag or the user account), an input received by scanning a computer readable code (for example, the tag identifier), an input received by swiping an item containing identification features such as a magnetic strip or an RFID tag or any other features. In some embodiment, a user can be provided with an identification feature, such as, for example, a card or component including, a magnetic strip, a computer readable code such as, for example, a barcode, an integrated circuit, such as, for example, a smart card, a signal emitting features such as, for example, an RFID tag, or any other identifying component. In some embodiments, this identification feature can be configured to assist in the determination of the subscription status of a user, and can, for example, facilitate the input of information to the exchange machine 100. In some instances, the identification feature can be associated with the user's device or profile

The controller can comprise, for example, a processor and a memory comprising stored instructions. In some embodiments, the processor can have a communications link with some of the features of the exchange machine 100 to receive inputs from these features. In some embodiments, the processor can further provide electronic signals to the features of the exchange machine 100 that control or direct the operation of these features. In some embodiments, the processor can receive electronic signals from each of the components of the exchange machine 100. In some embodiments, the processor can receive and process the user input, and in response to the input, direct the communication of information relating to the requested transaction to the user. This information can include, for example, account status, received battery acceptability, available battery inventory, pricing and availability of a subscription and/or an expanded subscription, and/or any other desired information. This information can allow the user to provide further inputs to the exchange machine 100 to select the user desired transaction. Advantageously, the use of the communications module 118 allows the exchange machine 100 to communicate information relating to products to the user, and the user to input information relating to the desired transaction into the exchange machine 100.

The exchange machine 100 can include additional features not depicted in FIG. 1. In some embodiments, the exchange machine 100 may be configured to accept electronic payment via a mobile telephone. In some embodiments, the payment may be received from a cellular service provider, such as when a user texts a specific code to a specific number, which instructs the cellular network to charge a user's account. In some embodiments, the payment may be made in a dedicated application, or app, on the user's mobile phone, or any other electronic payment method. These features can include, among others, a payment module. A payment module can include any feature or features configured to receive payment from a user. In some embodiments, a payment module can be configured to receive cash payment or to receive electronic payment. In some embodiments, a payment module can be a scanner configured for use with, for example, a credit card, or a debit card, or a cash input device. A person of skill in the art will recognize that the present disclosure is not limited to any specific feature for receiving payment, but that it broadly encompasses all features capable of receiving payment. In some embodiments, the payment module can be used, for example, to start a new subscription or to expand an existing subscription. In some embodiments, a subscription can be started or expanded with an on-line, in store, or two-way vending machine transaction. In some embodiments, the subscription can be associated by a single person, by a group of people, or by an entity. Such functions will allow the user to pay for features or receive credits at the exchange machine 100.

In some embodiments, the exchange machine 100 can comprise a network communications module. The network communications module can be configured to communicate with another entity on a network. In some embodiments, the network communications module can be configured to communicate with a server across a network, such as, for example, across the internet, and can include features configured for wired or wireless communication. In some embodiments, the network communications module may be configured to communicate with other exchange machines 100, a server, or other network and network-connected entities using the internet, a local area network, wide area network, RF communication, IR communication, cellular telephone networks, 3G and/or 4G and/or 5G networks, Wi-Fi, Bluetooth, or any other desired wireless or wired connection method.

The network communications module can be configured, in some embodiments, to transmit information to the server relating to the user, to a user account, to the user subscription account, to a user transaction, to user payment details, and/or any other desired information. In some embodiments in which the user identifies himself to the exchange machine 100, the network communications module can transmit this identification information to the server. The server can determine the status of the user account and/or user subscription account, and provide this information to the exchange machine 100. In some embodiments in which the user makes a payment to the exchange machine 100, the exchange machine 100 can provide information relating to the payment to the server. This information can include, for example, the amount of payment, whether a credit should be associated with the user account, payment account information such as, for example, a credit card or bank card number or identifier, or any other payment information. The server can then associate this payment information with the user account. The server may also allow the exchange machine 100 to communicate with the necessary components and/or source to help identify users, as introduced below.

In some embodiments, the exchange machine 100 can provide information relating to purchases by the user, such as, for example, details relating to the subscription purchased by the user or any other desired information. This information can be associated with the user account and/or user subscription account. In some embodiments, the information may relate to the number of batteries a user's subscription entitles the user to have checked out or in his/her possession. The information may include the status of batteries, battery packs, fuel cells, or other items a user's subscription entitles the user to receive from the exchange based service via exchange machines 100. In some embodiments, a user may provide instructions via a subscription or other method which requests the user have access to a battery, battery pack, etc., available for pick-up at any exchange machine 100.

In some embodiments, the network communications module can communicate information to the server relating to the status of the exchange machine 100. Thus, in some embodiments, the network communications module can send a signal to the server when the exchange machine 100 requires servicing such as, for example, replenishing of the stock of charged batteries or other vended items, removal of deposited discharged batteries or other used items, removal of discharged batteries that the exchange machine 100 cannot charge, or any other required service. A person of skill in the art will recognize that the network communications module can communicate a variety of other information with the server, and that the present disclosure is not limited to the above-described specific embodiments.

Some embodiments of the exchange machine 100 can include, for example, an inventory module. The inventory module can be configured to hold and store separate classes of batteries. In some embodiments, the inventory module can be divided into, for example, received batteries and batteries for dispensing. In some embodiments, the received batteries can be stored in a discharged inventory, and in some embodiments, the batteries for dispensing can be stored in a fresh battery inventory. In some further embodiments, the inventory module can store received batteries in either a battery recharging inventory or in a battery pickup inventory. In some embodiments, the batteries in the battery recharging inventory have been determined to be rechargeable at the exchange machine 100, and batteries in the battery pickup inventory have been determined to be non-rechargeable at the exchange machine 100.

Some embodiments of the exchange machine 100 can track the ownership of the received products in an ownership database or similar database and may enable partial exchange and/or a credited/charged exchange where the entity is only charged for portions of the exchanged product that need to be replaced (for example, degraded battery or worn USB connector, cracked screen, etc.). As such, the exchange machine 100 may enable the entity to identify portions of the product that the entity believes need to be replaced while maintaining the ability to identify for itself if other portions of the battery pack need to be replaced. For example, if the entity indicates that only batteries or other components of the product need to be replaced, but the exchange machine 100 identifies that the housing and/other components also need to be repaired or replaced, the exchange machine 100 may charge the entity the additional fees associated with the additional repair.

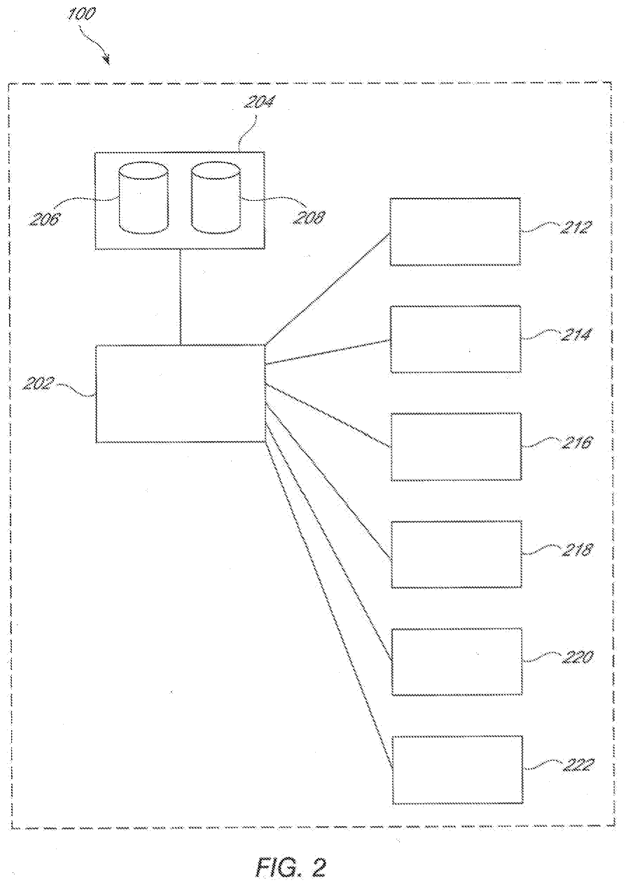

The details of the electrical and/or communicative interconnectivity of the different components of the exchange machine 100 are depicted in FIG. 2. As seen in FIG. 2, the components of the exchange machine 100 are interconnected. One embodiment of the exchange machine 100 can comprise a processor 202, memory 204 comprising, one or several databases 206, 208, the receiving module 212, (which may correspond to the receiving module 112 of FIG. 1), the rejection module 214, the dispensing module 216, the communications module 218, the storage module, the scanning module, and the inventory module 222. Though not shown in FIG. 2, the scanner module of the exchange machine 100 may be interconnected with the processor 202, memory 204, databases 206/208, the receiving module 212, and so forth.

As discussed above, the processor 202 can be configured to receive inputs from the different modules and components of the exchange machine 100 and to process these inputs based on instructions stored within the memory.

As depicted in FIG. 2, the memory 204 can be communicatively connected with the processor 202 to allow the processor to access the memory 204 so as to receive information from the memory 204 and to store information in the memory 204. In some embodiments, and as depicted in FIG. 2, the memory 204 comprises a plurality of databases 206, 208. In some embodiments, the memory 204 can comprise a single database. In some embodiments the memory 204 can comprise a plurality of databases such as, two, three, four, five, ten, twenty, one hundred, or any other number of databases. In some instances, the memory 204 may also store data received during operation of the exchange machine 100, for example profile information for users of the exchange machine 100, tag information for tags associated with deposited products and/or received from user devices in communication with the exchange machine 100, and so forth.

The databases 206, 208 can each comprise one or several organized collections of data. In some embodiments, the data stored in each of the databases 206, 208 can relate to the modules 212, 214, 216, 218, 220, 222. In some embodiments, for example, this information can relate to the inventory of the exchange machine 100, including, for example, the number of received products in the inventory, (e.g., that have been deposited into the exchange machine 100), the number of items available for distribution or exchange (if the exchange machine 100 is configured to dispense items in exchange for deposited products) in the inventory, any number of products deposited that cannot be attributed to any user, or any other inventory information. In some embodiments, for example, this information can relate to user subscription accounts and/or user accounts. In some embodiments, the databases 206, 208 may comprise external databases that provide user profile information, exchange offers information, external databases of information for identifying users based on captured information (for example, databases of electronic identifiers, electronic module identifiers, and so forth). The processor 202, for example via the communications module 218, may communicate with, send information to, or receive information from each of the databases 206, 208.

As depicted in FIG. 2, each of the receiving module 212, the rejection module 214, the dispensing module 216, the communications module 218, and the inventory module 222 are communicatively connected with the processor 202. This connection can allow the processor to send control signals to each of the modules 212, 214, 216, 218, 220, 222 and receive signals from each of these modules 212, 214, 216, 218, 220, 222.

The communicating connection between each of the modules 212, 214, 216, 218, 220, 222, the processor and the memory 204 and the processor can be a wired or wireless connection.

In some embodiments, the exchange machine 100 may be integrated into a blockchain system or other database system to enable product ownership tracking using the ownership database and tags described herein. In some embodiments, the exchange machine 100 may be enabled to operate in conjunction with the ownership database described herein to perform whole or partial product replacement as also described herein.

### Example Embodiment

In some embodiments, the exchange machine 100 enables a user to deposit a product as part of an immediate exchange for a new or replacement product, for credit, for cash, and so forth. The user depositing the product may use an app or similar software interface on a user device (such as a cellular phone, laptop, desktop, or similar electronic devices) or a user interface (not shown in the figures) of the exchange machine 100 . The user may use the user device or user interface to scan a tag that will be associated with the product being deposited. For example, the tag may be a removable tag that can be removably or permanently attached to the product and include a printed identifier or barcode, an electronic identifier (for example, via a radio frequency identifier (RFID) chip), or the like. In some instances the tag may be placed on an envelope or container into which the product can be placed when deposited into the exchange machine 100. In some instances, the tag may comprise a label printed on a receptacle, for example a locker, etc., into which the product can be placed for deposit with the exchange machine 100.

Once the user scans the appropriate tag (for example, with the appropriate scanning device or component, i.e., a barcode scanner, electronic signal scanner, optical scanner, and the like), the user may use the user device or user interface to associate the scanned tag with a user profile for the user. Thus, the user may tie the scanned tag to the user's profile, thereby associating the product with the tag and the product to the user's profile. In some embodiments, the user may bind the scanned tag value to an identifier for the user's profile, for example a profile name, identifying number, and the like.

In some embodiments, the user may communicate with the exchange machine 100 or a central system of exchange machines 100 via the user device. In some instances, exchange machine 100 may be communicate with other exchange machines 100 and other network systems, for example, systems of companies or entities that are involved with product exchanges, and so forth. Thus, the exchange machine 100 may communicate with cellular phone companies that enable exchanges of each other's products. The user may then communicate the association of the tag identifier for the deposited product with the user's profile to the exchange machine 100 and/or storage for the exchange machine 100.

The user may then deposit the tagged product into the exchange machine 100, for example, into the receiving module 112. The exchange machine 100 may scan the tag of the tagged product and confirm that the tagged product was deposited into the exchange machine 100 and update the user's profile to confirm that deposit. For example, when user uses the user device and/or the user interface of the exchange machine 100 to associate the product tag with the user profile, the exchange machine 100 may associate the product tag with the product identifier. In some instance, the user profiles may be associated with user profile identifying information in a lookup table or similar database.

Once the exchange machine 100 confirms the deposit of the product, the exchange machine 100 may work with the other network systems to identify an offer that the user may be eligible following the deposit of the product. In some instances, the exchange machine 100 may identify the product that was deposited, for example using one or more of the sensors described above or based on identification by the user that deposited the item (for example, as part of the user's user profile that is associated with the tag or via the user device or user interface). In some instances, the exchange machine 100 may comprise, via the processor 202, an ability to utilize machine vision components and/or corresponding processing components to identify the product based on features of the product captured by the sensors. For example, the processor 202 may determine the brand, model, type, etc., of product deposited based on an analysis of sensor data from the one or more sensors, including captured images, weight, size information, colors, materials, emitted signals, and so forth. When the scanning and processing of the product to determine product information occurs in the receiving module 112, the receiving module may convey the product to the storage module after the product information is determined.

Once the product information is determined, the exchange machine 100 may automatically determine whether the product qualifies for any offers.

For example, this determination may comprise reviewing the user profile for the user that deposited the product to determine if there is any indication in the user profile regarding the exchange of the product. If the user profile does include information about the exchange, the exchange machine 100 may determine whether the deposited product matches any details of the exchanged product in the user profile. In some embodiments, this determination may involve comparing information from one or more sources. For example, if the user profile identifies that the user will be exchanging a cell phone for a monetary value, the user profile may identify the model of phone to be deposited and the amount of money the user will receive in exchange. Thus, the exchange machine 100 may access other sources of information (for example, a database of phone information from one or more phone manufacturers or the like) to identify product information for the identified model of phone and compare the accessed product information with the product information determined based on scanning the deposited product. For other product types, the exchange machine 100 may access different sources for product information to compare the determined product information to determine offer compliance by the user.

Additionally, determining whether the deposited product qualifies for any offers may comprise the exchange machine 100 accessing lists of offers from one or more companies associated with the user profile (for example, a cell phone provider of the user, an internet provider, a manufacturer of the product, and the like). The exchange machine 100 may search these lists of offers to determine if the deposited product matches any products listed on the lists of offers.

When the exchange machine 100 determines that the deposited product does match the product information of a specified or identified offer or a listed offer, then the exchange machine 100 may update the user profile associated with the deposited product to indicate that the offer exists and corresponding conditions may be met. In some instances, the exchange machine 100 may confirm that the user has met the requirements of the offer and is due the benefit associated with the offer (for example, a monetary amount or an exchange product).

In some embodiments, when the exchange machine 100 scans the deposited product to determine the features of the deposited product, the one or more sensors may be used to determine a condition for the product, for example does it appear to have any damaged or broken components, any missing components, and so forth. Such additional features may be used in the determination that the deposited product did earn the user the corresponding benefit.

In some instances, the analysis of the exchange, offers, etc., related to deposited products may occur via a centralized processor that is related to or associated with the exchange machine 100, for example a centralized hub, or the like.

### Additional Embodiment

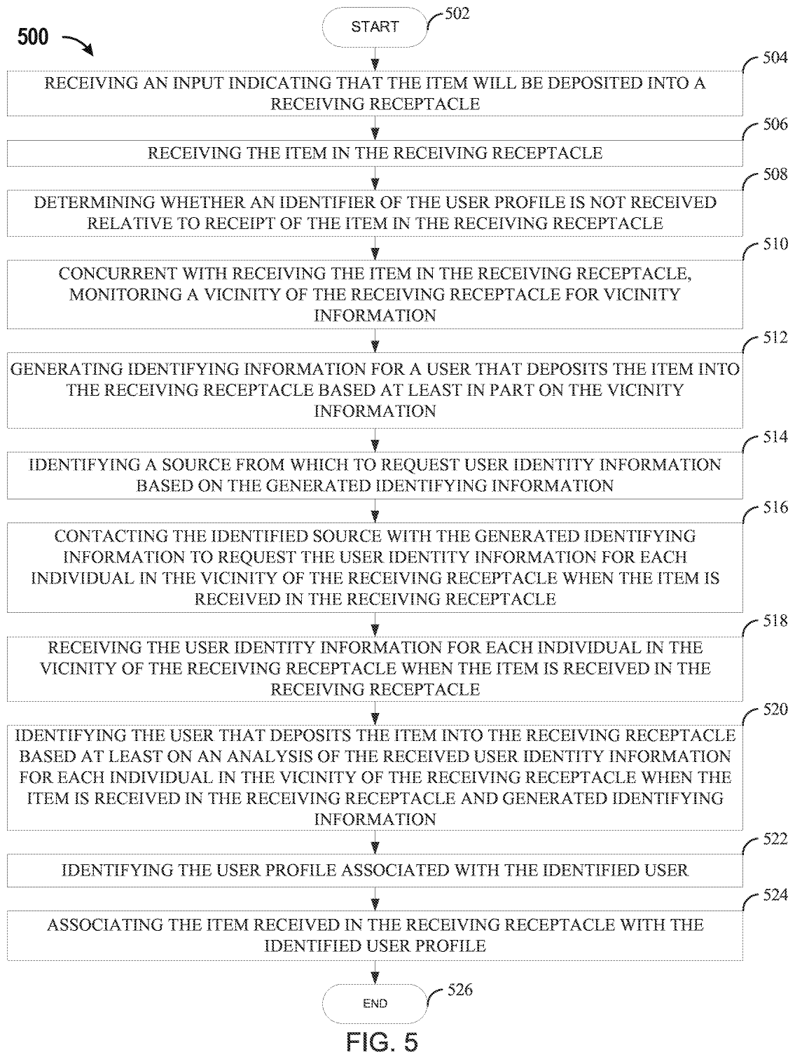

In some embodiments, the exchange machine 100 may inadvertently receive a product without any corresponding user information, as shown in an example method flow 500, which starts at block 502 of FIG. 5. For example, the user depositing the product may indicate, at block 504, that the product will be deposited into the exchange machine 100 but accidentally deposit the item without first scanning the tag and associating the tag with the user's user profile or may not affix the tag to the product before depositing the product. Additionally, communication issues, and the like may cause the user profile to not be conveyed to the exchange machine 100 to show the association between the user profile and the tag information. In such an instance, the exchange machine 100 may be configured to perform various steps to attempt to determine an identity for the user who deposited the product in the exchange machine 100, as described further below. In some embodiments, the input indicating that the item will be deposited may comprise selection on a user interface or user device.

In some instances, the exchange machine 100 may include one or more vicinity sensors that sense various conditions and aspects of an environment of the exchange machine 100. In some instances, the vicinity sensors may capture images of the environment or scan for electronic signals in the environment (for example, signals or identifiers from electronic devices, such as cellular signals or identifiers, Bluetooth signals or identifiers, WiFi signals or identifiers, nearfield communication signals or identifiers, and the like). In some instances, the exchange machine 100 may monitor biometric information, time information, environmental information, and/or any other identifier information. If the exchange machine 100 determines that the product is deposited, for example at block 508, the exchange machine 100 may determine whether corresponding user information was received. If the exchange machine 100 further determines that no user profile information (for example, an identifier) is received within a threshold period of time, the exchange machine 100 may then capture vicinity information from the environment. The environment of the exchange machine 100 may be monitored at all times or when the product is deposited into the exchange machine 100, at block 510. Thus, when the exchange machine 100 detects the product deposit without the corresponding user profile information, the exchange machine 100 may analyze the captured vicinity information to attempt to identify a user that deposited the item. In some embodiments, analyzing the captured vicinity information to attempt to identify a user that deposited the item comprises generating identifying information for the user based (at least in part) on the captured vicinity information, for example at block 512. Thus, the exchange machine 100 may detect, identify, and separate potentially identifying information (for example, images, communication signals, etc.) from the vicinity information and send the separated information to respective sources to help identify the user that deposited the product into the exchange machine 100.

In some embodiments, the exchange machine 100 may identify an appropriate information source to request for assistance based on the vicinity information, for example at block 514. The exchange machine 100 may contact the identified source with the generated identifying information to request identity information for the user associated with the generated identifying information, for example at block 516. For example, pictures of a face of the potential user may be sent to a source having such images as searchable with cross-references to names, and so forth. In some instances, when the vicinity information includes identification information for a cellular phone of the user likely to have deposited the product, the exchange machine 100 may contact the corresponding cellular company to request contact information and/or identity information corresponding to the identification information for the cellular phone from the vicinity information. Similarly, the exchange machine 100 may request assistance from other companies or entities to help identify the user that deposits the product based on the captured vicinity information.

Based on the request for assistance, the exchange machine 100 may receive a response from the source that comprises user identifying information for the user (or any and all individuals identified in the vicinity of the exchange machine 100 when the product was deposited, for example at block 518. The received response may include a user name, a user address, a user e-mail address, a user phone number, or a user profile identifier. Based on the received response, the exchange machine 100 may identify the user that deposited the product into the exchange machine and associate the deposited product with the identified user's account. If the user does not have an account, the exchange machine 100 may contact the user with options to pick up the deposited item or to create a user profile. When the exchange machine 100 determines that multiple users were in the vicinity when the product was deposited, the exchange machine 100 may contact each of the multiple users or apply one or more algorithms, machine learning models, and/or heuristics to determine which of the multiple users most likely deposited the product. Based on the received information and corresponding analysis, the exchange machine 100 may identify the user (and, thus, the user profile) associated with the deposited product, for example at blocks 520 and 522. Once the user that deposited the product is identified, the exchange machine 100 associates the product and/or tag with the user's profile, for example at block 524.

### Method of Updating Ownership of Tagged Products

The features of the two-way exchange based vending machine 100 (and/or mobile devices, and other devices) can be controlled to achieve the desired ownership tracking of one or more products.

For example, the vending machine 100 or another device may scan a tag and associate the tag with a product in the ownership database. The database may thus be used to verify or authenticate ownership of the tag (and thus the product) by any person or entity when the database is made public. In some embodiments, the database comprises a distributed ledger in a blockchain. In such an embodiment, the blockchain may be immutable and publicly accessible such that anyone can verify ownership of a product by accessing and decoding the blockchain entry associated with the product. When the database comprises a relational database that is publicly available, anyone can access the database to identify an owner associated with a particular tag identifier for the product in question.

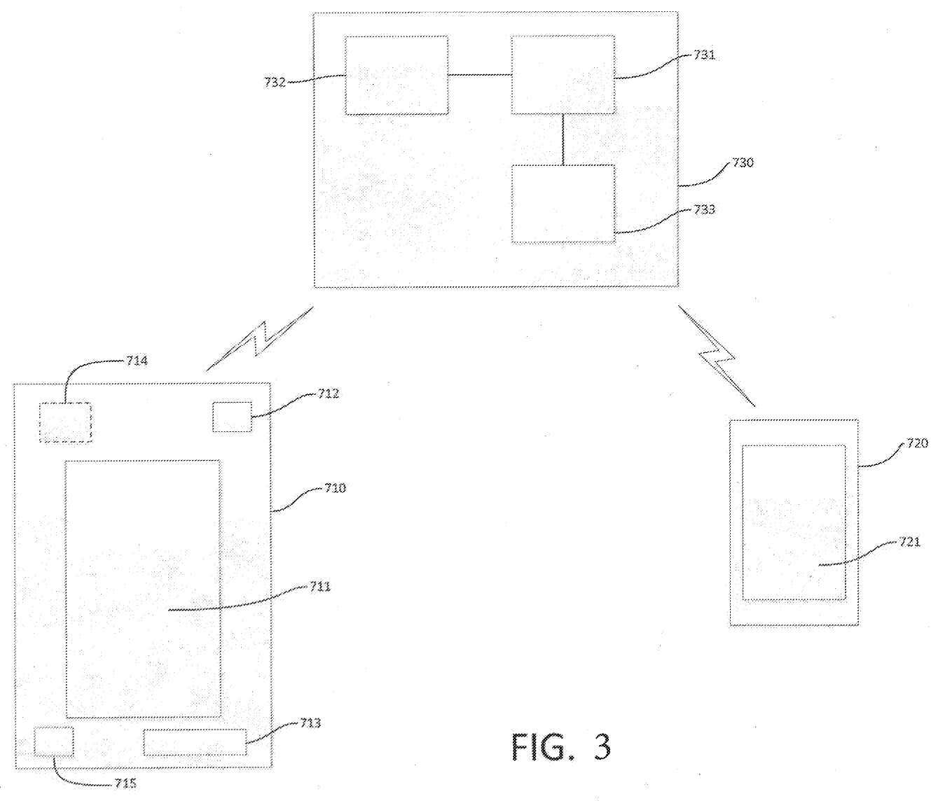

FIG. 3 illustrates a system for vending items using a “headless” or “dumb” vending machine. A vending system 700 comprises a vending unit 710, a mobile electronic device 720, and a central computer 730. Vending system 700 may vend batteries as described elsewhere herein. In some embodiments, vending system 700 may be configured to vend any desired product, for example, beverages, candy, food, books, music, electronics, or any other desired product. In some embodiments, the vending system 700 may be configured to provide a two-way exchange based vending procedure as described herein.

The vending unit 710 comprises a product display portion 711, a vending unit identifier 712, a dispensing port 713, a communication module 714, and a receiving port 715. It is notable that the vending unit 710 does not have a user interface, such as a payment port, a graphical interface comprising buttons for selecting a product to vend, or other similar features. Because the vending unit 710 lacks these features, it can be referred to as a “headless” or “dumb” vending machine.

The product display portion 711 may be a window into the vending unit 710 through which the products, including the product prices, may be seen. In some embodiments, the production display portion 711 may be a list of products, or chart or compilation of images of the products contained within the vending unit 710 and available for vending.

The vending unit identifier 712 may be a unique identifier assigned to a particular vending unit 710 which identifies the vending unit 710 among a plurality of other vending units. The vending unit identifier 712 may be an alphanumeric name or code, a QR code, an RFID tag, a barcode, or other similar unique identifier. The vending unit identifier 712 may be used to identify the particular vending unit 710 to a network or server which will be described below.

The dispensing port 713 is disposed in the vending unit 710 and provides a path through which a product is dispensed from the vending unit 710. The communication module 714 is located within the vending unit 710, and is connected to the vending machinery within the vending unit 710. The vending machinery is the mechanism by which a product is selected for dispensing and then dispensed through dispensing port 713. The communications module 714 is configured to communicate with a server or network which will be described later herein. The communication module 714 may comprise a receiver and/or a transmitter configured to communicate wirelessly with a local area network using Wi-Fi or similar communications protocols, with a wide area network over the internet, using a cellular network, a 3G network, a 4G network, Bluetooth, Zigbee, IEEE 802.11x, or any other desired wireless communication method or protocol.

The receiving port 715 is disposed in the vending unit and provides a path through which a user may deposit an item, such as a spent or used battery as part of a two-way exchange described herein. An item received in the receiving port 715 may be taken into the vending unit 710 and sorted and/or stored within the unit 710. In some embodiments, the received unit may be exchanged for a similar item.

The vending system 100 may advantageously include a mobile electronic device 720 such as a cellular phone, smart phone, personal digital assistant, tablet computer, laptop or notebook computer, netbook, ultrabook, or any other mobile computing or communication device. The mobile electronic device 720 has an interface 721 configured to receive a user's input. The interface 721 may be a touch-screen type interface, a graphical user interface, an alphanumeric key pad, or other similar known mobile device interface. The mobile communication device 720. In some embodiments, the mobile electronic device 720 and its interface 721 may substitute as the user interface that is present on standard vending machines. Instead of selecting products and providing payment on the vending unit 710, these functions are performed using the mobile electronic device 720 via an internet site using a mobile web browser, or a dedicated app, or other similar method.

The mobile electronic device 720 is in wireless communication with a central computer 730. Central computer 730 may be a server, network node, or other similar device known in the art. Central computer 730 comprises a processor 731, which is in electrical communication with a database 732 and a communication unit 733. The communication unit 733 is configured to communicate with both the communications module 714 of the vending unit 710, and the mobile electronic device 720. The communication unit 733 is configured to both transmit and receive signals to and from the vending unit 710 and the mobile electronic device 720. The database 732 may store information regarding the price of items in the vending units 710, users of the vending system 700, subscribers, and other information as will be described herein. The database 732 may also store information regarding a user's exchange subscription information, such as how many items has the user subscribed and/or paid for, or how many items does the user currently have checked out.

The processor 731 controls and coordinates the operations of the central computer 730 and the vending system 700. In some embodiments, the communication unit is configured to communicate with other devices or networks, such as the internet, credit card accounts, cellular telephone accounts, PayPal, e-wallets such as Google wallet, and any other desired system in order to facilitate payment and to process payments for products to be vended. The communication unit 733 may be configured to communicate via a wireless or wired connection or both. For example, the central computer may be configured to wirelessly communicate with vending unit 710, and may have a wired connection to financial networks, the internet, or other networks to facilitate processing electronic payments.

In some embodiments, the central computer 730 may be a web server or a host for an e-commerce site. A user may register for an account via a web server or similar network interface, and deposit money into an account or sign up for a subscription service for using the vending system 700. The user's account information may be stored in the database 732.

In some embodiments, the vending system 700 may be integrated into a blockchain system or other database system to enable product ownership tracking using the ownership database and tags described herein. In some embodiments, the vending system 700 may be enable to operate in conjunction with the ownership database described herein to perform whole or partial product replacement as also described herein.

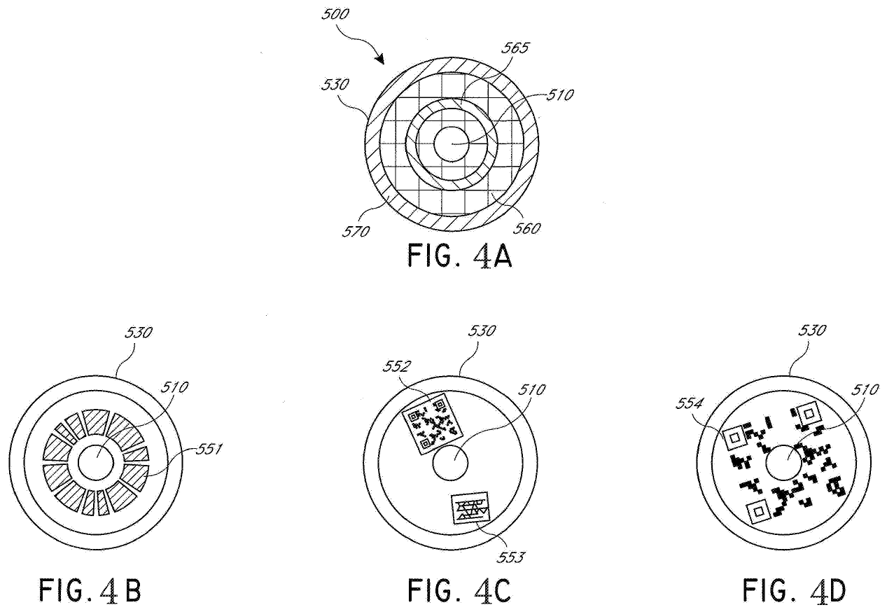

In some embodiments, a battery may have a rotation-invariant, visually identifiable pattern disposed on an end or on a terminal. FIG. 4A depicts an end view of an embodiment of a battery 500 having visually identifiable concentric rings. Battery 500 comprises a first terminal 510, and a first concentric ring 560 and a second concentric ring 565. Insulating jacket 530 comprises an end portion 570. The pattern of concentric rings is visually identifiable. Concentric rings 560 and 565 may comprise a particular color pattern, shading pattern, width pattern, marking pattern (e.g. dotted, dashed, etc. lines), or other visually identifiable pattern. The visually identifiable pattern of concentric rings 560 and 565 may further comprise, end portion 570 of insulating jacket 530. In some embodiments, concentric rings 560 and 565 may be disposed around or near the second terminal 520. In some embodiments, the concentric rings 560 and 565 may be disposed on or around either end or terminal of the battery. In some embodiments, concentric rings 560 and 565 may be disposed on or around both ends and terminals. In some embodiments, battery 500 is presented for identification in an identification apparatus such as a battery vending machine or battery exchange machine. The identification apparatus may comprise a test port and visual scanner, camera, barcode reader or other device configured to visually identify a battery. A database of patterns, images, or symbols which positively identify a battery may be referenced by the identification apparatus. A battery comprising a positively identifiable image contained within the database may be accepted by the identification apparatus, and a battery without a positively identifiable image may be rejected.

FIG. 4B depicts an end view of an embodiment of a battery having a radial barcode. Battery 500, as depicted, has a rotation agnostic radial barcode 551 on an end. Radial barcode has scannable segments which radiate out from the center of positive terminal 510. In some embodiments, the radial barcode may be located on the negative terminal 520. By alternating the width of the segments, a code can be programmed onto the end of each battery. In some embodiments, a unique barcode may be used to encode the type or size of battery, or the origin of the battery. In some embodiments, individual batteries may have their own individual identifiers. By assigning each battery a unique identifier or barcode, the battery vending machine, battery exchange machine or other battery receiving apparatus may be able to identify the account associated with a particular battery and can update or credit account information based on the unique identifier or barcode.

Battery 500 may have a rotation agnostic QR code or other two dimensional code located on an end. FIG. 4C depicts an end view of an embodiment of a battery having a quick-recognition (QR) code 552 and a high capacity color barcode (HCCB) 553. The QR code 552, HCCB 553, or other two-dimensional barcode may appear different depending on the rotation of the battery about an axis, however, the battery vending machine, battery exchange machine, or other battery receiving apparatus is capable of reading and interpreting a two-dimensional barcode regardless of the rotation of the battery about an axis. Thus, the two-dimensional barcode may be rotation agnostic. Each battery may have a unique QR code, high capacity color code, or other two-dimensional code. When a battery is vended or supplied, the battery barcode is associated with the account, transaction, customer, purchaser, user, borrower, or other entity. When the battery is returned to a battery vending machine, battery exchange machine, or other battery receiving apparatus, the battery is identified by its unique code, and the account, transaction, customer, borrower, purchaser, user, or other entity can be accessed and credited or debited based on the particular transaction. In some embodiments, an account holder would not need to input any personal information into the battery exchange machine, battery vending machine, or other battery receiving apparatus in order to identify itself, but the account holder would be identified automatically based on the unique, rotation agnostic code on the end of each battery and its association with an account.

FIG. 4D depicts an end view of an embodiment of a battery having a radial QR-type code. In some embodiments, battery 500 may have a radial QR-type code 554 disposed on an end of the battery. A two dimensional barcode such as the QR-type code 554 depicted may encode battery information and be associated with an account as described elsewhere herein. In some embodiments, QR-type code 554 may be an HCCB or other type of two-dimensional barcode as described elsewhere herein.

In some embodiments, end portion 570 of insulating jacket 530, together with concentric rings 560 and 565 may comprise a circular pharma code pattern. End portion 570 and concentric rings 560 and 565 may vary in width in accordance with a pharma code pattern. A barcode scanner may be configured in a test port of an identification apparatus which reads a portion or all of the circular pharma code and positively identifies or rejects battery 500. The pharma code may be configured as disclosed elsewhere herein.

In some embodiments, the portions of FIGS. 4A-4D may be used in conjunction with the unique tags described herein for ownership tracking and/or partial replacement, as described herein.

### Communication Flow Diagram

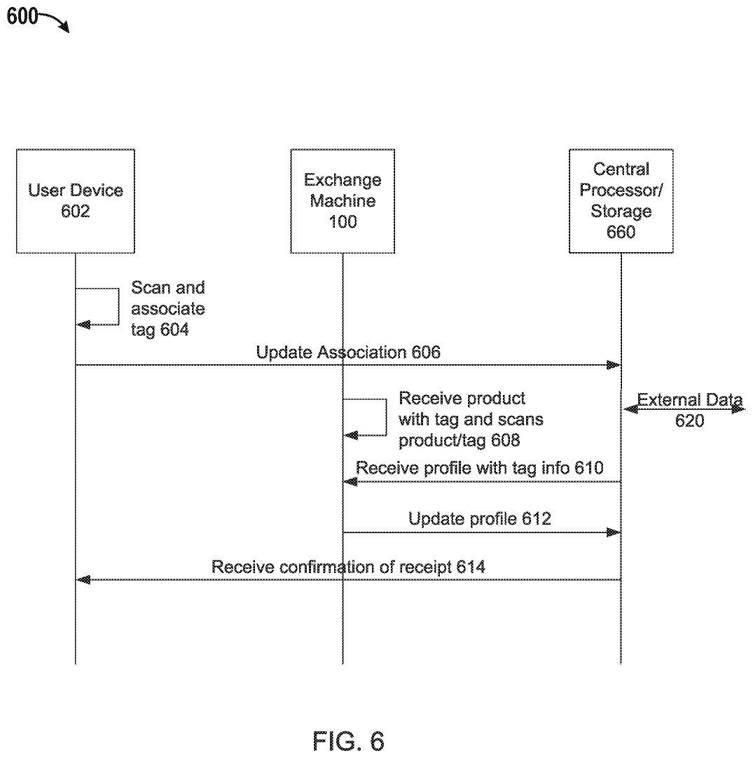

FIG. 6 is one embodiment of a communication flow diagram 600 depicting communications exchanged between, for example, the exchange machine 100, a user device 602, and a central processor or storage 660. Though not shown explicitly, each of the user device 602, the exchange machine 100, and the central processor or storage 660 may communicate or be coupled via a network (not shown). Accordingly, each of the depicted components may be configured to communicate over a network connection, for example.

In one embodiment, the user device 602 is configured to receive a user input (not shown). This user input may comprise the user registering to deposit a product into the exchange machine 100 or using the user interface for the exchange machine 100 or the like. Once the user indicates that the product will be deposited with the exchange machine 100, the user may, at 604, scan and associate a tag with the product to be deposited. As described above, the tag may be a physical, electronic, or similar that has a unique identifier. This unique identifier may be associated with the user profile (for example, by the user device 602) and communicate to the central processor and/or storage 660 at 606. The association between the user profile and the tag (and, thus, the product) will be stored in a memory or similar structure, though not shown.

The exchange machine 100 may receive the product with the tag and scan the tag at 608. The exchange machine 100 may also receive the user profile associated with the tag from the central processor/storage 660 at 610. Once the exchange machine 100 has both the scanned product and the tag information as well as the user profile with tag information, the exchange machine 100 may update the user profile 612 to indicate the change in ownership or possession of the product, that the user has qualified for some benefit for exchanging or depositing the product, or charge the user when the exchange was partial, for example to replace a battery, screen, or the like. In some instances, one of the exchange machine 100 and/or the central processor/storage 660 may generate a confirmation of receipt of the product to the user device 602 at 614. In some embodiments, the central processor/storage 660 may access data from external sources, for example 620. Such data may be used to determine the user that deposited the item or product, as described herein, should the user profile associated with a scanned tag not be provided within the threshold period of time.

The steps of the above described methods are exemplary only. The steps of the processes may be performed in any order desired, and steps may be added or omitted from the above processes, as desired.

The technology is operational with numerous other general purpose or special purpose computing system environments or configurations. Examples of well-known computing systems, environments, and/or configurations that can be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and run under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method of associating an item with a user profile, comprising:
receiving an input indicating that the item will be deposited into a receiving receptacle;
receiving the item in the receiving receptacle;
determining whether an identifier of the user profile is not received relative to receipt of the item in the receiving receptacle;
concurrent with receiving the item in the receiving receptacle, monitoring a vicinity of the receiving receptacle for vicinity information;
generating identifying information for a user that deposits the item into the receiving receptacle based at least in part on the vicinity information;
identifying a source from which to request user identity information based on the generated identifying information;
contacting the identified source with the generated identifying information to request the user identity information for each individual in the vicinity of the receiving receptacle when the item is received in the receiving receptacle;
receiving the user identity information for each individual in the vicinity of the receiving receptacle when the item is received in the receiving receptacle;
identifying the user that deposits the item into the receiving receptacle based at least on an analysis of the received user identity information for each individual in the vicinity of the receiving receptacle when the item is received in the receiving receptacle and generated identifying information;
identifying the user profile associated with the identified user; and
associating the item received in the receiving receptacle with the identified user profile.

2. The method of claim 1, wherein the identifier of the user profile is not received relative to receipt of the item in the receiving receptacle when the identifier of the user profile is not received within a threshold period of time of the receipt of the item in the receiving receptacle.

3. The method of claim 1, wherein the vicinity information comprises one or more of wireless communication information, captured images of the vicinity, biometrics information, time information, environmental information, or identifier information.

4. The method of claim 3, wherein the wireless communication information comprises a cellular communication module identifier, a Bluetooth communication module identifier, a Wi-Fi communication module identifier, or a near-field communication module identifier.

5. The method of claim 3, wherein the captured images comprise images of faces or other identifying features of individuals that interact with the receiving receptacle or enter into a threshold area around the receiving receptacle.

6. The method of claim 1, wherein identifying a source from which to request user identity information based on the generated identifying information comprises determining a type of identifying information generated based at least in part on the vicinity information.

7. The method of claim 1, wherein the user identity information comprises one or more of a user name, a user address, a user e-mail address, a user phone number, or a user profile identifier.

8. A system for associating an item with a user profile, comprising:
a receiving receptacle configured to receive the item deposited by a user;
an input circuit configured to receive an input indicating that the item will be deposited into the receiving receptacle;
a memory circuit configured to store instructions; and
a hardware processor configured to, in response to the instructions:
identify an identifier of the user that deposited the item into the receiving receptacle;
determine, based on a lookup table stored in a data store, a user profile identifier that corresponds to the identifier of the user; and
associate a tag identifier with the user profile identity, wherein the tag identifier is uniquely associated with the item deposited by the user in the receiving receptacle.

9. The system of claim 8, further comprising a tag scanner configured to scan a tag associated with the item deposited into the receiving receptacle and identify the tag identifier for the tag associated with the item deposited into the receiving receptacle.

10. The system of claim 8, wherein the hardware processor is further configured to generate an update to a user profile of the user to indicate that the user deposited the item into the receiving receptacle.

11. The system of claim 8, further comprising:
a detection circuit configured to detect when the item is deposited in the receiving receptacle and identify one or more parameters of the item deposited into the receiving receptacle; and
a plurality of environmental sensors configured to monitor aspects of an environment of the receiving receptacle and capture information of potential users in the environment when the detection circuit detects that the item is deposited into the receiving receptacle.

12. The system of claim 11, further comprising a communication circuit configured to communicate with a central server and one or more external data sources, wherein the hardware processor is further configured to communicate with the one or more external data sources to confirm an identity of the user that deposited the item into the receiving receptacle based on the captured information of the potential users in the environment when the item was deposited into the receiving receptacle.

13. A method of depositing an item in a receiving receptacle, comprising:
providing a unique tag for scanning by a user using a user device, the unique tag associated with the item being deposited into the receiving receptacle;
providing the receiving receptacle for access by the user depositing the item;
receiving the item in the receiving receptacle;
receiving a user identifier for the user via an interface, the user identifier associated with the unique tag by the user device;
scanning the unique tag for the item deposited into the receiving receptacle;
updating a user profile having the user identifier for the user to indicate that the item associated with the unique tag was deposited into the receiving receptacle.

14. The method of claim 13, wherein the unique tag associated with the item comprises a removable tag physically coupled to the item being deposited into the receiving receptacle, an identifier for an envelope or container into which the item is placed for depositing into the receiving receptacle, a displayed tag identifying the receiving receptacle into which the item is deposited, or an electronic identifier for the item being deposited into the receiving receptacle.

15. The method of claim 13, wherein the interface comprises a physical interface at the receiving receptacle, a graphical user interface at the receiving receptacle, or a communication interface between the user device and the receiving receptacle.

16. The method of claim 13, wherein the received identifier comprises an identifier for the user profile.

17. The method of claim 13, further comprising:
identifying an offer for which the user has registered or is eligible;
determining whether the deposited item in the receiving receptacle qualifies for the offer; and
updating the user profile based on the determination whether the deposited item in the receiving receptacle qualifies for the offer.

18. The method of claim 17, wherein determining whether the deposited item in the receiving receptacle qualifies for the offer comprises:
identifying the item deposited in the receiving receptacle;
determining, based on the identified offer, a list of qualifying items eligible for the offer and a benefit of the offer;
determining that the item deposited in the receiving receptacle matches one of the qualifying items; and
update the user profile to include the benefit of the offer based on the determination that the item deposited in the receiving receptacle matches one of the qualifying items.

19. The method of claim 13, further comprising scanning the item deposited in the receiving receptacle to capture one or more features of the deposited item.

20. The method of claim 19, wherein scanning the deposited item comprises one or more of capturing an image of the deposited item, weighing the deposited item, or scanning the deposited item for or with radio waves or signals.
